(19) United States
(12) Patent Application Publication
(10) Pub. No.: US 2013/0215122 A1
(43) Pub. Date: Aug. 22, 2013

(54) DISPLAY APPARATUS WITH LIGHT GUIDE BASED SOLAR CONCENTRATOR

(71) Applicant: Rambus Inc., (US)

(72) Inventors: Timothy A. McCollum, Avon Lake, OH (US); Gregg M. Podojil, Brecksville, OH (US); Ian Hardcastle, Santa Cruz, CA (US); Jeffery R. Parker, Richfield, OH (US); Matthew R. Wancata, Strongsville, OH (US); Fumitomo Hide, San Jose, CA (US)

(73) Assignee: RAMBUS INC., Sunnyvale, CA (US)

(21) Appl. No.: 13/766,947

(22) Filed: Feb. 14, 2013

Related U.S. Application Data
(60) Provisional application No. 61/599,982, filed on Feb. 17, 2012.

(51) Int. Cl. F21V 8/00; G09G 3/00

(52) U.S. Cl. CPC G02B 6/0018; G09G 3/00
USPC 345/501; 362/607; 349/62

(57) ABSTRACT

A display apparatus includes a display, a primary light concentrator, a concentrator light guide, and a solar cell. The primary light concentrator is arranged in tandem with the display, and the primary light concentrator is configured to concentrate incident light into an array of output regions. The concentrator light guide receives light from the primary light concentrator. The concentrator light guide includes light redirecting elements aligned with the output regions of the primary light concentrator to redirect light from the primary light concentrator along the concentrator light guide toward an edge thereof. The solar cell is located adjacent the edge of the concentrator light guide.

### RELATED APPLICATION DATA

This application claims the benefit of U.S. Provisional Patent Application No. 61/599,982, filed Feb. 17, 2012, the disclosure of which is incorporated herein by reference in its entirety.

### BACKGROUND

Mobile or handheld devices have become increasingly popular. These devices typically rely on a rechargeable battery for operating power. However, battery life is an issue for the mobile or handheld devices. Light energy shows promise as a way to provide supplemental power and/or recharge the battery, but integration of an effectively-sized solar cell with the mobile or handheld device places restrictions on the minimum size of the device.

### BRIEF DESCRIPTION OF THE DRAWINGS

FIGS. 1 and 2 are schematic views showing parts of an exemplary display apparatus.

FIG. 3 is a schematic view showing parts of an exemplary display.

FIG. 4 is a schematic view showing parts of another exemplary display apparatus.

FIG. 5 is a schematic view showing parts of another exemplary display.

FIGS. 6 and 7 are schematic views showing parts of an exemplary pixel arrangement.

FIGS. 8 and 9 are schematic views showing parts of another exemplary pixel arrangement.

FIGS. 10-13 are schematic views showing parts of another exemplary pixel arrangement.

FIGS. 14 and 15 are schematic views showing parts of another exemplary pixel arrangement.

FIGS. 16 and 17 are schematic views showing parts of another exemplary pixel arrangement.

FIGS. 18A-18C are schematic views showing an exemplary means for image distortion correction.

FIGS. 19A-19C are schematic views showing another exemplary means for image distortion correction.

FIGS. 20-26 are schematic views showing parts of other exemplary display apparatuses.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface.

A display apparatus includes a display, a primary light concentrator, a concentrator light guide, and a solar cell. The primary light concentrator is arranged in tandem with the display, and the primary light concentrator is configured to concentrate incident light into an array of output regions. The concentrator light guide receives light from the primary light concentrator, the concentrator light guide including light redirecting elements aligned with the output regions of the primary light concentrator to redirect light from the primary light concentrator along the concentrator light guide toward an edge thereof. The solar cell is located adjacent the edge of the concentrator light guide.

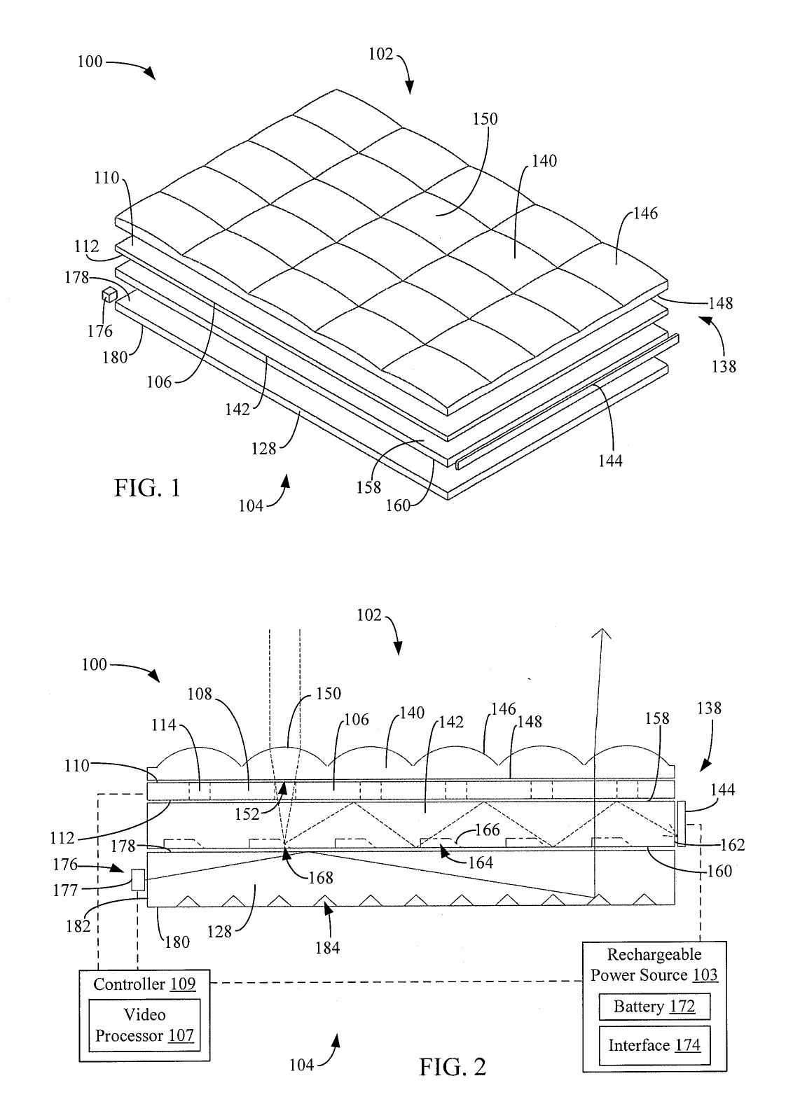

With initial reference to FIGS. 1-3, an exemplary embodiment of the display apparatus is shown at 100. Although not specifically shown, in some embodiments, the display apparatus 100 is included as part of a mobile or handheld device. In this disclosure, the term “mobile or handheld device” is meant to broadly encompass any suitable device including a rechargeable power source 103. Examples include, without limitation, mobile telephones such as smart phones, handheld video games, tablets, laptops, and any other suitable device. The display apparatus 100 is retained by a housing (not shown) of the mobile or handheld device such that a front side 102 of the display apparatus 100, which is configured to display a video image, is viewable by a user of the mobile or handheld device. A rear side 104 of the display apparatus 100 is typically disposed within the housing and not viewable by a user of the mobile or handheld device.

The display apparatus 100 includes a light guide based solar concentrator 138 in tandem with a display 106. Locating the solar concentrator 138 in tandem with the display 106 allows the display area of the display apparatus 100 not only to display video or still images, but also to collect and concentrate ambient light via the light guide based solar concentrator 138. This allows the size of the mobile or handheld device in which the display apparatus is included to be reduced compared with a device in which the display and the solar cell are arranged side-by-side. The concentrated light is converted to electrical energy by a solar cell 144 to supplement and/or charge the rechargeable power source 103. By collecting and concentrating the ambient light, the size of the solar cell can be reduced. This reduces the cost of the solar cell and/or allows a solar cell having a greater conversion efficiency to be used. The components of the display apparatus 100, including the light guide based solar concentrator 138 and the display 106, are discussed in greater detail below.

Display

The display apparatus 100 includes a display 106 having an array of pixel sets 108 that are configured to produce images in response to a video signal. Operation of the pixel sets 108 is controlled by a video processor 107 and controller 109. A first major surface 110 of the display 106 faces a front side 102 of the display apparatus 100, and a second major surface 112 of the display 106 is opposite the first major surface 110 and faces the rear side 104 of the display apparatus 100. The major surfaces 110, 112 of the display 106 may be any suitable size and shape, and the display 106 may include any suitable number and arrangement of pixel sets 108. In the example shown, the major surfaces 110, 112 of the display 106 are rectangular in shape. In an example, the pixel sets 108 are sets of red, green and blue pixels. In another example, the pixel sets 108 are sets of three or more pixels that are red, green, blue or other colors. In another example, the pixel sets 108 include monochromatic pixels that receive light from red, green and blue or other color light sources that are sequentially illuminated. In another example, the pixel sets 108 include monochromatic pixels that receive light from a multi-chromatic or monochromatic light source.

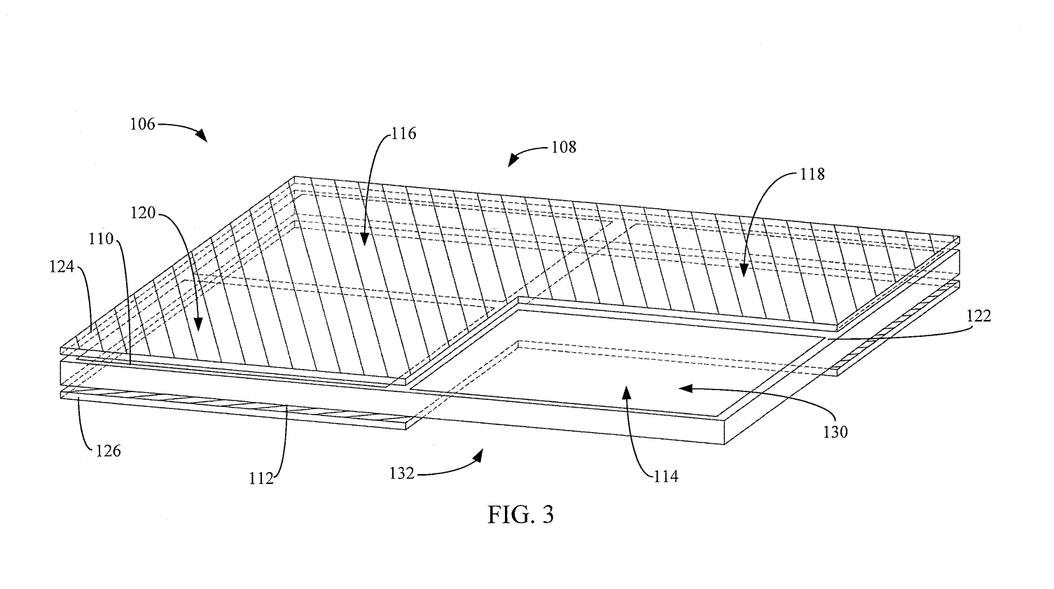

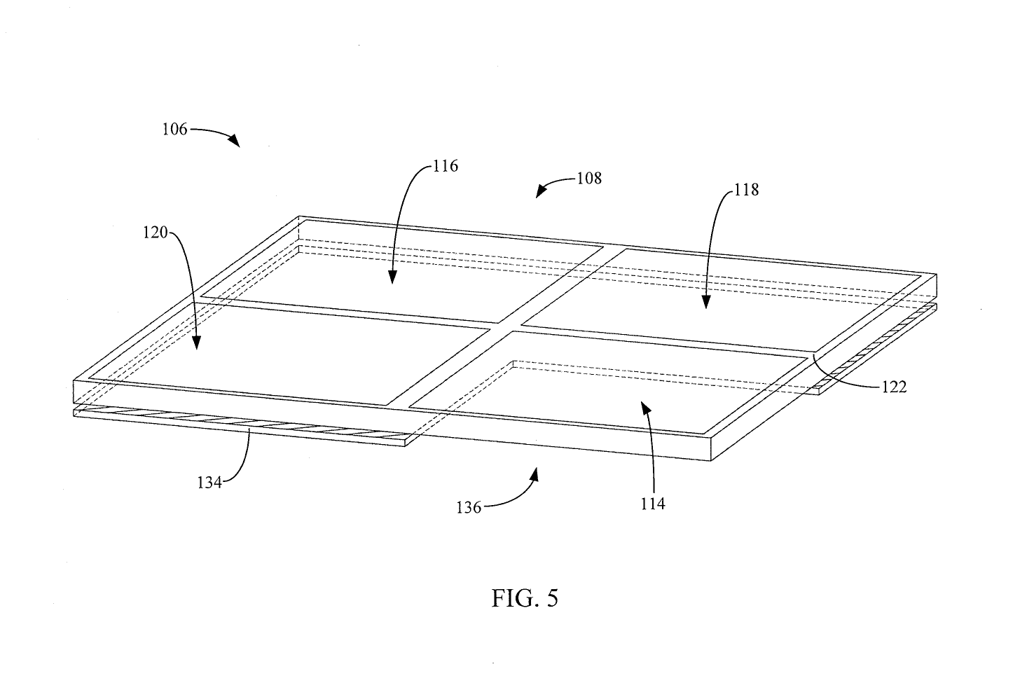

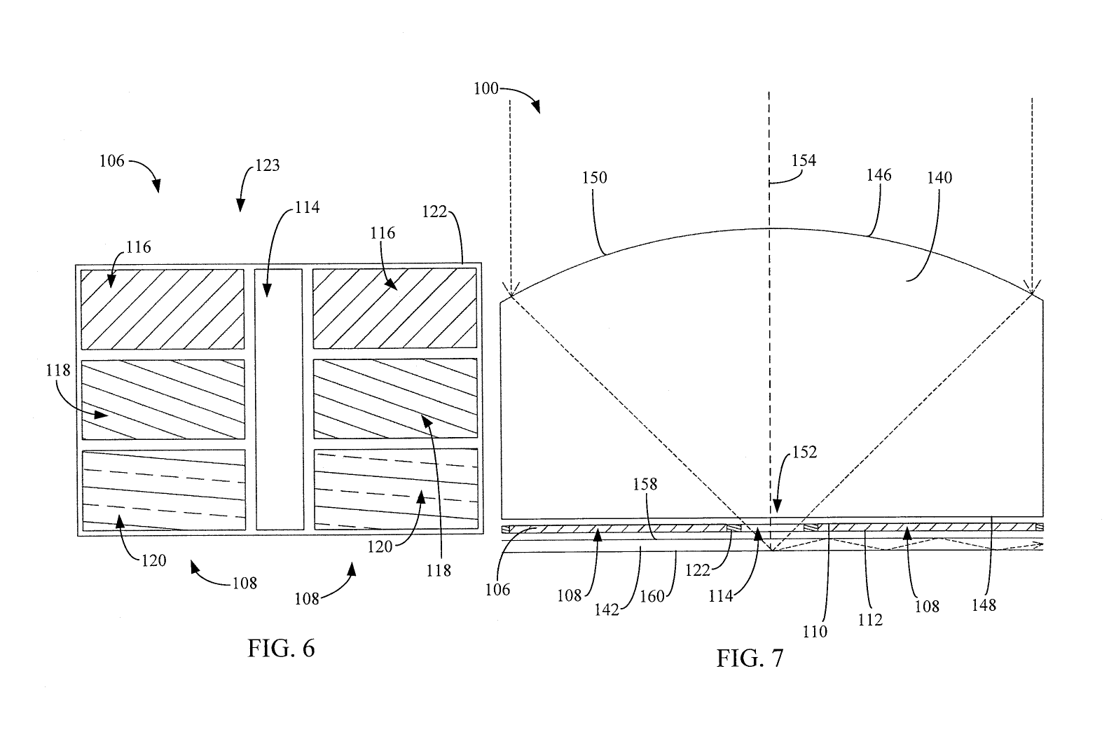

The pixel sets 108 include pixels 116, 118, 120, e.g., red, green and blue pixels, respectively, (FIG. 3) and are arranged relative to transmissive regions 114 of the display 106. The transmissive regions 114 allow ambient light incident on the front side 102 of the display 106 to pass through the display 106 in a direction toward the rear side 104 of the display 106. In some embodiments, the transmissive regions 114 are air gaps. In other embodiments, the transmissive regions 114 include light-transmissive windows in the structure of the display. In yet other embodiments, the transmissive regions 114 include respective regions of varying refractive index material or gradient index material that provide a secondary focusing effect. In other embodiments, the transmissive regions 114 include a region of optically-transmissive material. Exemplary arrangements of the pixel sets 108 relative to the transmissive regions 114 are described below in relation to the embodiments shown in FIGS. 6-17.

With specific reference to FIG. 3, in one embodiment, the display 106 is a liquid crystal display (LCD). The pixels 116, 118, 120 of each pixel set 108 are embodied as an array of liquid crystal light valves controlled by the video processor 107 and controller 109 (FIG. 2). The light valves are separated and retained by an inter-pixel structure 122. Although not specifically shown, the inter-pixel structure 122 may also retain circuitry and/or electronics for operating the pixel sets 108, and any other appropriate components. A polarizer film 124, 126 is proximate each major surface 110, 112 of the display 106. The polarizer film 124 is configured to polarize light emitted from a backlight light guide 128. The polarized light passes through the pixel set 108 to backlight the LCD. The polarizer film 126 analyzes the light that passes through the pixel set. As shown in the exemplary embodiment, each polarizer film 124, 126 are selectively patterned with windows 130, 132 defined therein, and the windows 130, 132 are aligned with the transmissive regions 114 of the display 106. The windows 130, 132 of each polarizer 124, 126 are typically formed by a punch process, laser etching, lithography, or another suitable process. In one example, the windows 130, 132 are formed prior to application of the polarizer film 124, 126 to the major surface 110, 112 of the display 106 with the windows 130, 132 aligned with the respective transmissive regions 114. In another example, the polarizer film 124, 126 are applied to the major surface 110, 112 of the display 106 and portions of the polarizer film 124, 126 aligned with the transmissive regions 114 are removed to form the windows 130, 132.

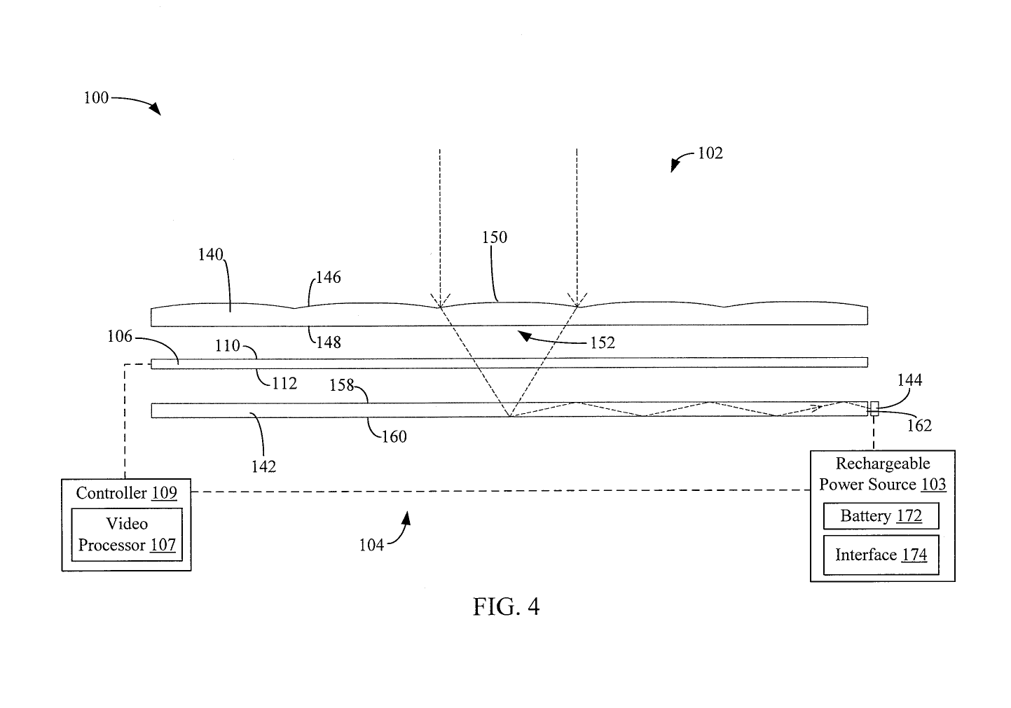

In another embodiment shown in FIGS. 4 and 5, the display 106 is configured as a reflective or emissive display and the backlight light guide 128 is omitted. With specific reference to FIG. 5, in one example, the display 106 is an organic light-emitting diode (OLED) display. The pixel sets 108 of the OLED display 106 include pixels 116, 118, 120, e.g., red, green and blue pixels, respectively, embodied as organic compounds that emit light in response to an electric current controlled by the video processor 107 and controller 109. The organic compounds are separated and retained by the inter-pixel structure 122. A patterned OLED substrate 134 is proximate the second major surface 112 of the display 106 and includes windows 136 respectively aligned with the transmissive regions 114 of the display 106. The OLED substrate 134 is typically formed from an opaque material (e.g., silicon) by a suitable process such as etching. Each window 136 and transmissive region 114 is devoid of light-generating structure, and allows ambient light to pass therethrough. In other examples, the display 106 is embodied as an electrophoretic display, electroluminescent display, plasma display, field emission display, deformable membrane display, micro electro-mechanical system (MEMS) display, or any other suitable type of display. For the sake of brevity, the structure of other suitable embodiments of the display 106 is not described in detail.

Light Guide Based Solar Concentrator

Referring now to FIGS. 1-5, arranged in tandem with the display 106 is a light guide based solar concentrator 138 that is configured to collect and concentrate ambient light. The light guide based solar concentrator 138 includes a primary light concentrator 140 and a concentrator light guide 142 arranged in tandem with the display 106 such that the display 106 is located between the primary light concentrator 140 and the concentrator light guide 142. The primary light concentrator 140 and the concentrator light guide 142 are respectively configured to focus the ambient light through the transmissive regions 114 of the display 106 and to direct the focused light toward the solar cell 144. The solar cell 144 generates from the concentrated light electrical energy that supplements and/or charges the rechargeable power source 103. As shown in FIGS. 2 and 4, ambient light at the front side 102 of the display apparatus 100 and incident on the primary light concentrator 140 is collected and focused through the transmissive regions 114 of the display 106. The focused light is incident on the concentrator light guide 142, which redirects the light that then propagates through the concentrator light guide 142 by total internal reflection. The light exits the concentrator light guide 142 and is incident on the solar cell 144.

Primary Light Concentrator

The primary light concentrator 140 is configured to collect and focus ambient light incident on the front side 102 of the display apparatus 100 through the transmissive regions 114 of the display 106. The primary light concentrator 140 includes a first major surface 146 facing the front side 102 of the display apparatus 100 and a second major surface 148 opposite the first major surface 146 and facing the rear side 104 of the display apparatus 100. The second major surface 148 of the primary light concentrator 140 is juxtaposed with the first major surface 110 of the display 106.

In some embodiments, the primary light concentrator 140 is also configured to include touchscreen functionality to detect the presence and location of a touch (e.g., by a user or a stylus) at the front of the display. Examples include resistive, capacitive, and surface acoustic wave touchscreens. Depending on the implementation of the touch screen functionality, the primary light concentrator 140 functions as a light concentrator as described in this specification and serves as a functional layer of a touch input assembly. In other embodiments, the primary light concentrator 140 serves as a complete touch input assembly or lies below a touch input assembly.

The primary light concentrator 140 includes an array of light concentrator elements 150 at the first major surface 146 thereof. In some embodiments, the light concentrator elements 150 are refractive optical elements arranged as discrete or interconnected elements and having any suitable physical and optical characteristics (e.g., index of refraction, size, shape, curvature, orientation, geometry). Examples of suitable refractive optical elements include lenticular elements such as lenslets (e.g. shown as an arrangement of interconnected rectangular lenslets in FIG. 1) or lenticular grooves. In other embodiments, the light concentrator elements 150 include diffractive optical elements or holographic elements.

Each light concentrator element 150 is configured to pass the focused light through an associated output area 152 at the second major surface. The arrangement of the output areas 152 at the second major surface 148 of the primary light concentrator 140 is a function of the type and arrangement of the light concentrator elements 150 at the first major surface 146 of the primary light concentrator 140. In an example wherein the light concentrator elements 150 are lenslets, ambient light incident on the first major surface 146 of the primary light concentrator 140 is output from the second major surface 148 in an arrangement of discrete areas that correlate to the arrangement of the lenslets. In an example wherein the light concentrator elements 150 are parallel lenticular grooves, ambient light incident on the first major surface 146 of the primary light concentrator 140 is output from the second major surface 148 in an arrangement of discrete bands that correlate to the arrangement of the lenticular grooves.

Each light concentrator element 150 and associated output area 152 are arranged relative to a respective transmissive region 114 of the display 106 such that the focused light passes through a respective transmissive region 114. By concentrating the incident ambient light into an array of output regions 152, the primary light concentrator 140 increases the amount of light passed through the transmissive regions 114 of the display 106 than would occur if no concentration mechanism were employed.

Arrangement of Primary Light Concentrator Relative to Display

The dimensions and arrangement of each light concentrator element 150 are configured to reduce the maximum angle through which incident light is refracted in order to pass through the transmissive region 114 of the display 106. In an example, the size of each light concentrator element 150 is reduced such that a given light concentrator element 150 overlies a minimum number of pixel sets 108, the curvature of the light concentrator element 150 is minimized, and the optical axis of each light concentrator element 150 is centered on the transmissive region 114. By reducing the angle through which the light passing through the primary light concentrator 140 is refracted, distortion of the image output by the pixel sets 108 is also reduced. Distortion will be discussed in greater detail below.

FIGS. 6 and 7 show an exemplary embodiment of the display apparatus 100 in which a light concentrator element 150 is aligned with a plurality of pixel sets 108 and a transmissive region 114. FIG. 6 is a plan view of the display 106 showing two pixel sets 108, each pixel set having pixels 116, 118, 120 arranged in a column. The two pixel sets 108 are separated by a transmissive region 114. FIG. 7 is a side view of the display apparatus 100 showing the second major surface 148 of the primary light concentrator 140 juxtaposed with the first major surface 110 of the display 106. The transmissive region 114 is centered in the pixel group 123 of the two pixel sets 108 and transmissive region 114, and the light concentrator element 150 overlies the pixel group 123 with the optical axis 154 of the light concentrator element 150 centered on the transmissive region 114. The arrangement of the light concentrator element 150 relative to the pixel group 123 reduces the maximum angle through which incident light is refracted in order to pass through the transmissive region 114. For purposes of description, the pixel group 123 illustrated in FIGS. 6 and 7 will be referred to as a “3×3 array.”

In some embodiments, the light concentrator elements 150 of the primary light concentrator 140 are embodied as discrete or interconnected lenslets (e.g., rectangular lenslets) respectively associated with the pixel groups 123. In other embodiments, the light concentrator elements 150 of the primary light concentrator 140 are embodied as lenticular grooves extending parallel to the transmissive region 114 in a direction orthogonal the plane of FIG. 7. In such embodiments, multiple instances of the pixel groups 123 are arranged in the direction orthogonal the plane of FIG. 7 such that the transmissive regions 114 are aligned with the lenticular groove, and the lenticular groove is configured to concentrate incident light into each of the transmissive regions 114.

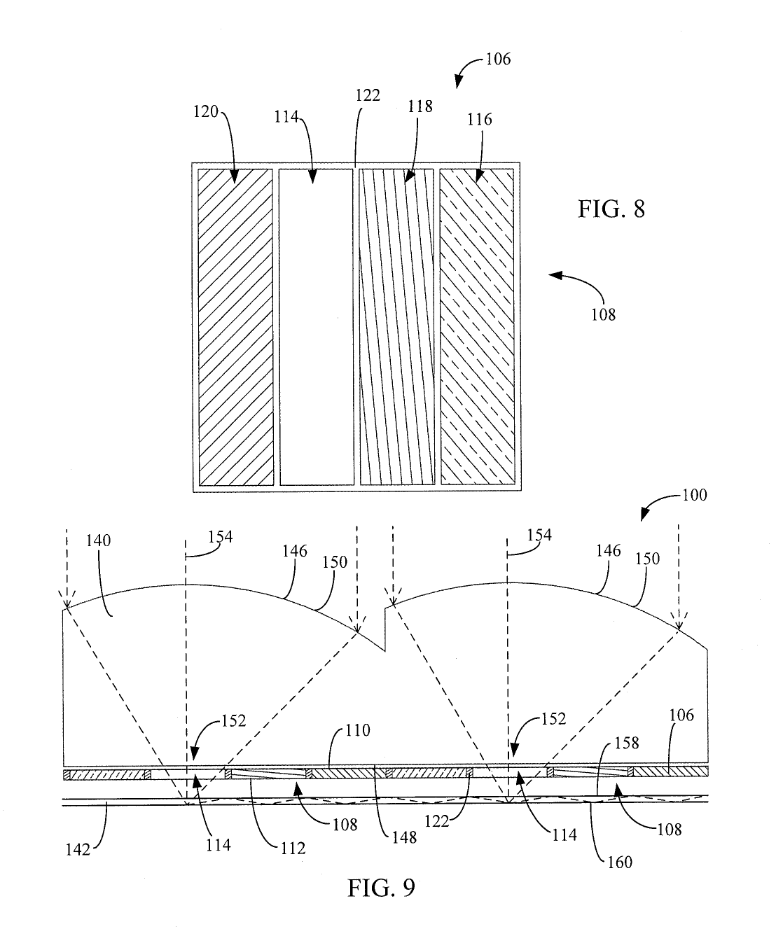

FIGS. 8 and 9 show an exemplary embodiment of the display apparatus 100 in which a light concentrator element 150 is aligned with a respective pixel set 108 and transmissive region 114 arranged in a one-dimensional array. FIG. 8 is a plan view of the display 106 showing two pixels 116, 118 of the pixel set 108 separated from the third pixel 120 by a transmissive region 114. FIG. 9 is a side view of the display apparatus 100 showing the second major surface 148 of the primary light concentrator 140 juxtaposed with the first major surface 110 of the display 106. Each instance of the pixel set 108 and transmissive region 114 in FIG. 9 is associated with a respective light concentrator element 150. The optical axis 154 of the light concentrator element 150 is centered on the transmissive region 114, and the light concentrator element 150 is truncated so that it does not extend beyond the third pixel 120. Although the transmissive region 114 is not centered with respect to the one-dimensional array, the optical axis 154 of the light concentrator element 150 is centered on the transmissive region 114 to reduce the maximum angle through which incident light is refracted in order to pass through the transmissive region 114.

In some embodiments, the light concentrator elements 150 of the primary light concentrator 140 are embodied as discrete or interconnected lenslets (e.g., rectangular lenslets), each lenslet respectively associated with the one dimensional array. In other embodiments, the light concentrator elements 150 of the primary light concentrator 140 are embodied as lenticular grooves extending parallel to the transmissive region 114 in a direction orthogonal the plane of FIG. 9. In such embodiments, multiple instances of the one-dimensional array are arranged in the direction orthogonal the plane shown in FIG. 9 such that the transmissive regions 114 are aligned, and a lenticular groove is aligned with the transmissive regions 114 and configured to concentrate incident light into each of transmissive regions 114.

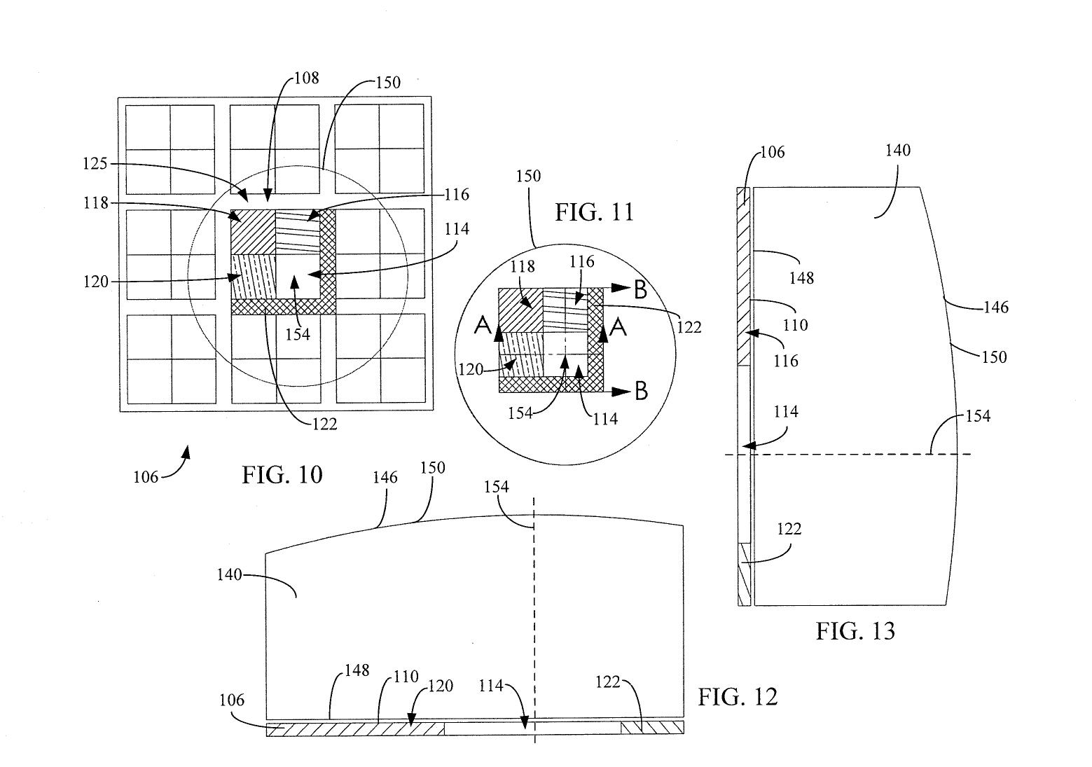

FIGS. 10-13 show an exemplary embodiment of the display apparatus 100 in which a light concentrator element 150 is aligned with a respective pixel set 108 and transmissive region 114 arranged in a two-dimensional array. FIG. 10 is a plan view of the display 106 showing multiple instances of pixel groups 125 that each forms a 2×2 array, while FIG. 11 is a plan view showing a single instance of the 2×2 array. The light concentrator element 150 is aligned with the 2×2 array with the optical axis 154 of the light concentrator element 150 centered on the transmissive region 114. FIG. 12 is a side view of the display apparatus 100 showing the second major surface 148 of the primary light concentrator 140 juxtaposed with the first major surface 110 of the display 106 from direction A-A (FIG. 11), while FIG. 13 is a side view of the display apparatus 100 showing the second major surface 148 of the primary light concentrator 140 juxtaposed with the first major surface 110 of the display 106 from direction B-B (FIG. 11). As shown in FIGS. 12 and 13, the light concentrator element 150 is truncated so that it does not extend beyond the sides of the inter-pixel area 122 surrounding the 2×2 array. In some embodiments, the light concentrator elements 150 of the primary light concentrator 140 are embodied as discrete or interconnected lenslets (e.g., rectangular lenslets), each lenslet respectively associated with a respective 2×2 array.

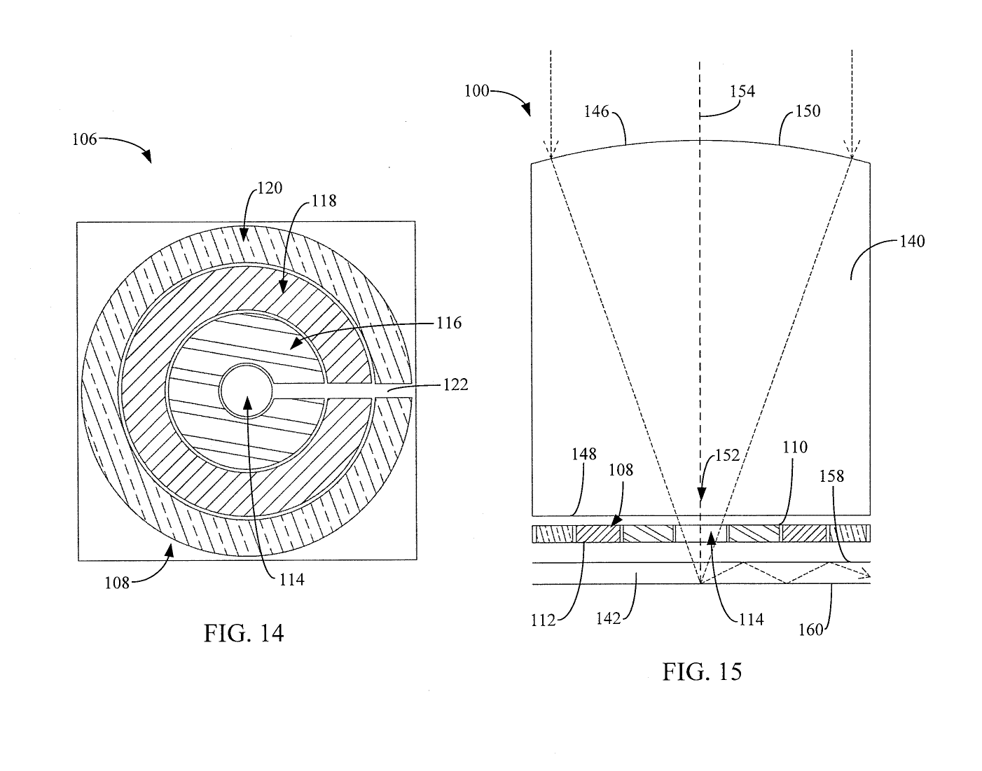

FIGS. 14 and 15 show an exemplary embodiment of the display apparatus 100 in which a light concentrator element 150 is aligned with a respective pixel set 108 and transmissive region 114 arranged concentrically. FIG. 14 is a plan view showing the pixels 116, 118, 120 of the pixel set 108 arranged concentrically about the transmissive region 114. The radial dimension of the respective pixels 116, 118, 120 decreases with increasing distance from the center of the transmissive region 114 so that the areas of the pixels 116, 118, 120 are the same or approximately the same. The arrangement of the pixel set 108 and transmissive region 114 are located within a rectangular area, and those portions of the rectangular area not occupied by the pixel set 108 and transmissive region 114 may form part of the inter-pixel area 122 between respective pixel sets 108. FIG. 15 is a side view of the display apparatus 100 showing the second major surface 148 of the primary light concentrator juxtaposed with the first major surface 110 of the display 106. The optical axis 154 of the light concentrator element 150 is centered on the transmissive region 114. In some embodiments, the light concentrator elements 150 of the primary light concentrator 140 are embodied as discrete or interconnected lenslets (e.g., rectangular lenslets), and each lenslet is respectively associated with a concentrically arranged pixel set 108 and transmissive region 114.

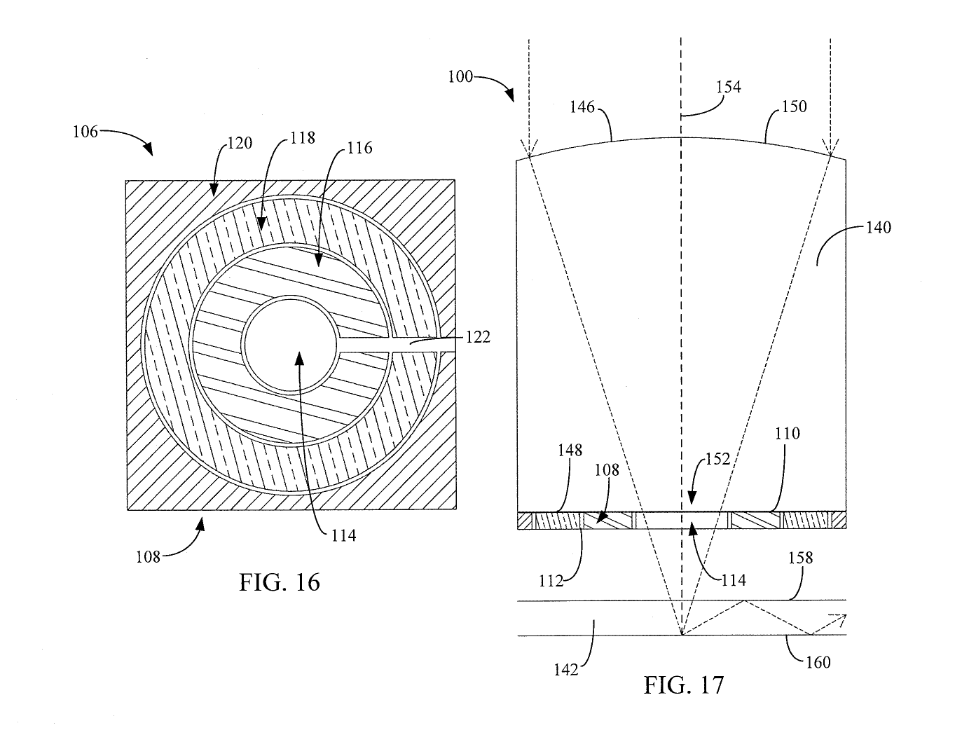

FIGS. 14 and 15 show the pixels 116, 118, 120 concentrically arranged in circular shapes. In other embodiments, the concentrically-arranged pixels 116, 118, 120 are other suitable concentrically-arranged shapes (e.g., triangles, squares, pentagons, hexagons, octagons). In still other embodiments, the respective pixels 116, 118, 120 are different types of concentrically-arranged shapes. For example, FIGS. 16 and 17 show another exemplary embodiment of the display apparatus 100 in which a light concentrator element 150 is aligned with the pixel set 108 and transmissive region 114 arranged concentrically. The pixels 116, 118, 120 of the pixel set 108 are arranged concentrically about the transmissive region 114. Two of the pixels 116, 118 proximate the transmissive region 114 are arranged in circular shapes. The shape of the third pixel 120 is defined by the area between the outermost circle and the rectangular border.

Image Distortion

As described above, the dimensions and arrangement of each light concentrator element 150 are configured to reduce the maximum angle through which light incident on the front side 102 of the display apparatus 100 is refracted in order to pass through the transmissive region 114. This also reduces the distortion of images output by the pixel sets that pass through the primary light concentrator 140. But in some embodiments, even the slightest distortion to the image output by the pixel sets 108 is undesired. Furthermore, in other embodiments, the dimensions and arrangement of the light concentrator elements results in several pixel sets 108 being arranged relative to a single transmissive region 114, thereby resulting in a larger-sized light concentrator element 150 that provides for a larger angle through which incident light is refracted in order to pass through the transmissive region 114.

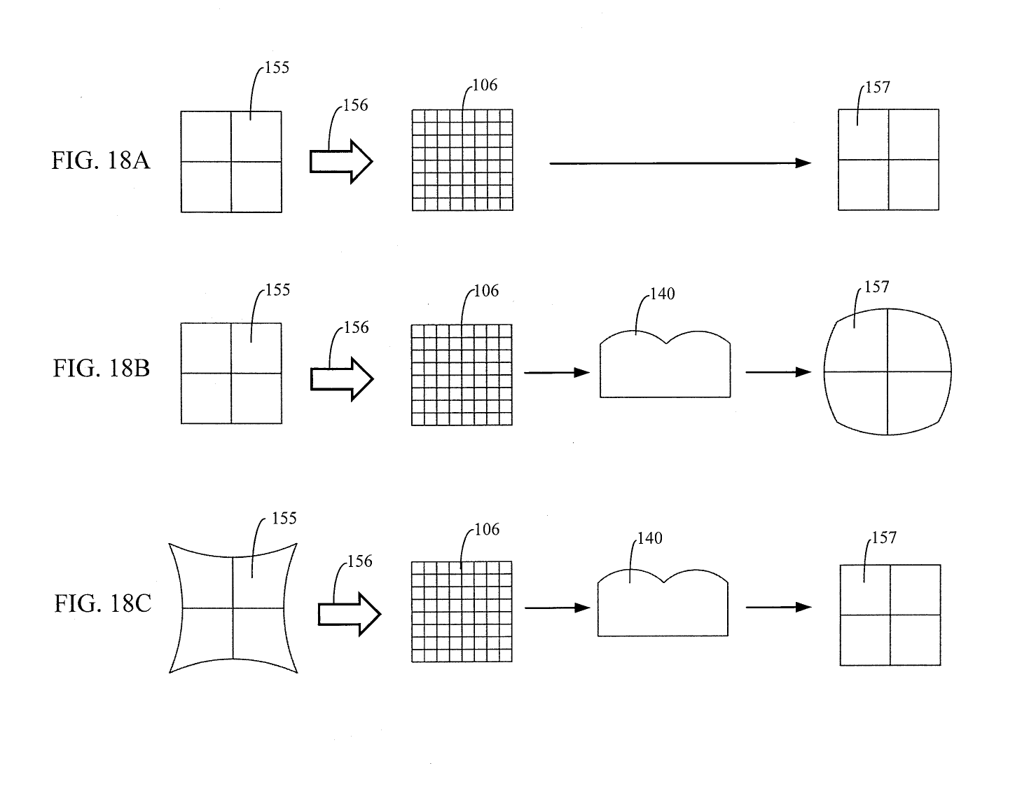

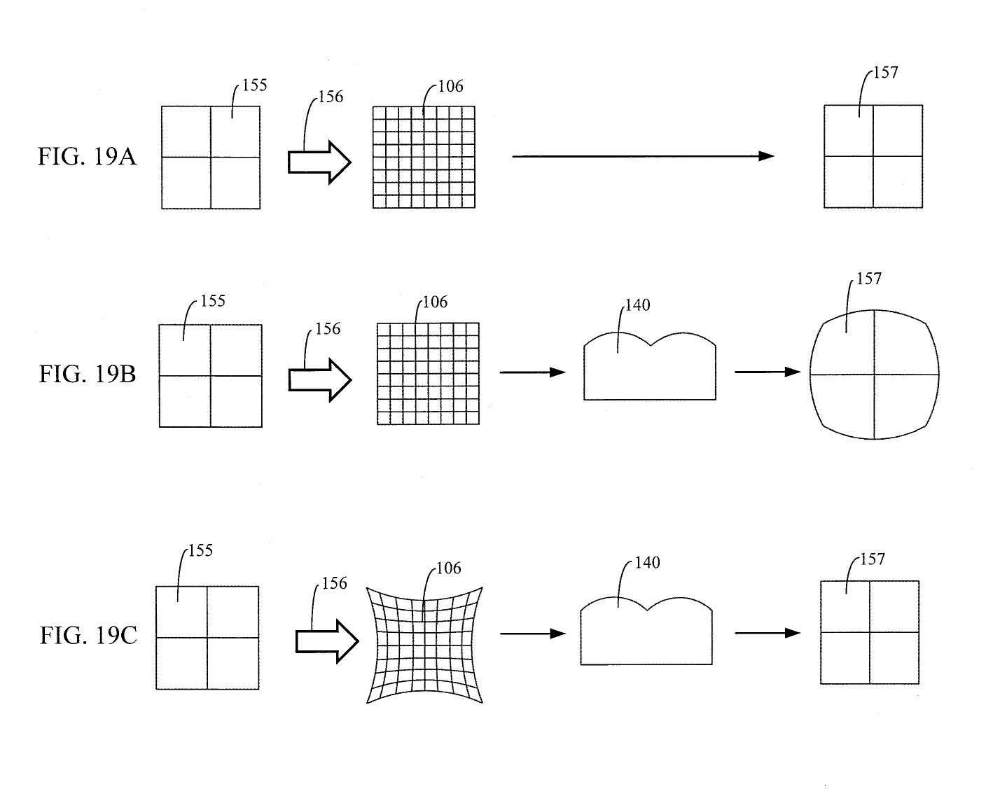

FIGS. 18A-18C and 19A-19C schematically illustrate exemplary techniques for correcting the image distortion caused by the light concentrator elements 150 of the primary light concentrator 140. FIGS. 18A and 19A show an input image 155 to be displayed on the display apparatus 100 that either does not include a primary light concentrator 140 or that includes a primary light concentrator 140 that introduces only a minimal amount of distortion to the displayed image. In the illustrated embodiment, the image 155 is a square containing a cross. The input image 155 is processed by the video processor 107 (FIG. 1) to output a video signal 156 representing the input image 155 that is used to drive the pixel sets 108 of the display 106. The display apparatus 100 outputs an image 157 at the front side 102 of the display apparatus 100 without distortion relative to the input image 155. FIGS. 18B and 19B show the input image 155 to be displayed on the display apparatus 100 that includes a primary light concentrator 140, which will introduce distortion to the displayed image. The video signal 156 drives the pixel sets 108 of the display 106 to output a corresponding image that passes through the primary light concentrator 140 and is distorted. The result is that the output image 157 is displayed at the front side 102 of the display apparatus 100 distorted relative to the input image 155.

In the embodiment shown in FIG. 18C, the technique for reducing the image distortion includes subjecting the input image 155 to a pre-distortion that, when displayed through the primary light concentrator 140, is canceled by the image distortion caused by the light concentrator elements 150 of the primary light concentrator 140. This pre-distortion may be performed, for example, by the video processor 107 when generating the video signal 156. The pre-distorted image 155 and/or video signal 156 are rendered by the pixel sets 108 and passes through the primary light concentrator 140. Compensation for the distortion of the output of the display 106 caused by the primary light concentrator 140 is made by pre-distorting the input image 155 by way of the video signal 156. Thus, the output image 157 is displayed at the front side 102 of the display apparatus 100 as intended.

In the embodiment shown in FIG. 19C, the technique for reducing the image distortion is provided by arranging the pixel sets 108 of the display 106 in an array that is shaped to compensate for the geometric distortion caused by the primary light concentrator 140 (e.g., in a non-rectangular array). The input image 155 by way of the video signal 156 is rendered by the pixel sets 108 and passes through the primary light concentrator 140. Compensation for the distortion of the output of the display 106 caused by the primary light concentrator 140 is made by the spatial arrangement of the pixel sets 108, and the output image 157 is displayed at the front side 102 of the display apparatus 100 as intended.

Concentrator Light Guide

Referring again to FIGS. 1-5, the concentrator light guide 142 is configured to receive the light passed through the transmissive regions 114 from the primary light concentrator 140. The concentrator light guide 142 is a solid article made from, for example, acrylic, polycarbonate, poly(methyl-methacrylate) (PMMA), glass, or other appropriate material. The concentrator light guide 142 includes a first major surface 158 and a second major surface 160 opposite the first major surface. The concentrator light guide 142 is configured to propagate light by total internal reflection between the first major surface 158 and the second major surface 160. The length and width dimensions of each of the major surfaces 158, 160 are greater, typically ten or more times greater, than the thickness of the concentrator light guide 142. The thickness is the dimension of the concentrator light guide 142 in a direction orthogonal to the major surfaces.

At least one edge surface extends between the major surfaces of the concentrator light guide 142 in the thickness direction. The total number of edge surfaces depends on the configuration of the concentrator light guide 142. In the case where the concentrator light guide 142 is rectangular, the light guide has four edge surfaces. In other embodiments, the concentrator light guide 142 has a different shape, and the total number of edge surfaces is different. Depending on the geometry of the light guide, each edge surface may be straight or curved, and adjacent edge surfaces may meet at a vertex or join in a curve. Moreover, each edge surface may include one or more straight portions connected to one or more curved portions. The edge surface through which light from the light source is output from the concentrator light guide will now be referred to as a light output edge 162.

The concentrator light guide 142 includes light redirecting elements 164 in, on, or beneath at least one of the major surfaces 158, 160. Light redirecting elements 164 that are in, on, or beneath a major surface will be referred to as being “at” the major surface. Each light redirecting element 164 is aligned with a respective transmissive region 114 of the display 106, and is configured to redirect focused light from the primary light concentrator 140 along the concentrator light guide 142 toward the output edge 162. Light guides having such light redirecting elements are typically formed by a process such as stamping, molding, embossing, extruding, laser machining, or another suitable process.

Exemplary light redirecting elements 164 include features of well-defined shape that are small relative to the linear dimensions of the major surfaces, which are referred to herein as micro-optical elements. The smaller of the length and width of a micro-optical element is less than one-tenth of the longer of the length and width of the light guide, and the larger of the length and width of the micro-optical element is less than one-half of the smaller of the length and width of the light guide. The length and width of the micro-optical element is measured in a plane parallel to the major surface of the light guide for planar light guides or along a surface contour of the major surface for non-planar light guides.

FIG. 2 shows exemplary prismatic light redirecting elements 164 having a light redirecting surface 166 non-parallel to the major surface 160 of the concentrator light guide 142 to predictably reflect the focused light incident thereon. In some embodiments, the light redirecting surface 166 includes a reflective surface. The light focused by the primary concentrator 140 is incident on the concentrator light guide 142 at an angle nominally normal to the major surface 160 and is incident on a light redirecting element 164 at or near the location 168 at which the light is focused.

The light redirecting element 164, and more specifically the light redirecting surface 166, redirects the light typically such that the light is incident on the first major surface 158 of the concentrator light guide 142 at an angle of incidence greater than the critical angle. The light then propagates in the concentrator light guide 142 by total internal reflection, preferentially toward the output edge 162. However, light redirected by some of the light redirecting elements 164 may propagate directly to the output edge 162 without being totally internally reflected at the major surfaces 158, 160 of the concentrator light guide 142. The light propagating in the concentrator light guide 142 increases in intensity with decreasing distance from the output edge 162 due to the cumulative effect of light redirected by other light redirecting elements 164. The propagated light is incident on the output edge 162, and is output from the concentrator light guide 142.

The light redirecting elements 164 are arranged at the major surface 158, 160 of the concentrator light guide 142 to maximize the intensity of the light output from the output edge 162. Because the light is predictably reflected or refracted at the light redirecting surface 166 of the light redirecting element 164, the light redirecting elements 164 can be arranged in a pattern (e.g., a staggered arrangement) at the major surface 158, 160 to minimize the likelihood that light propagating in the concentrator light guide 142 is incident on a downstream light redirecting element 164 and scattered or extracted from the concentrator light guide 142.

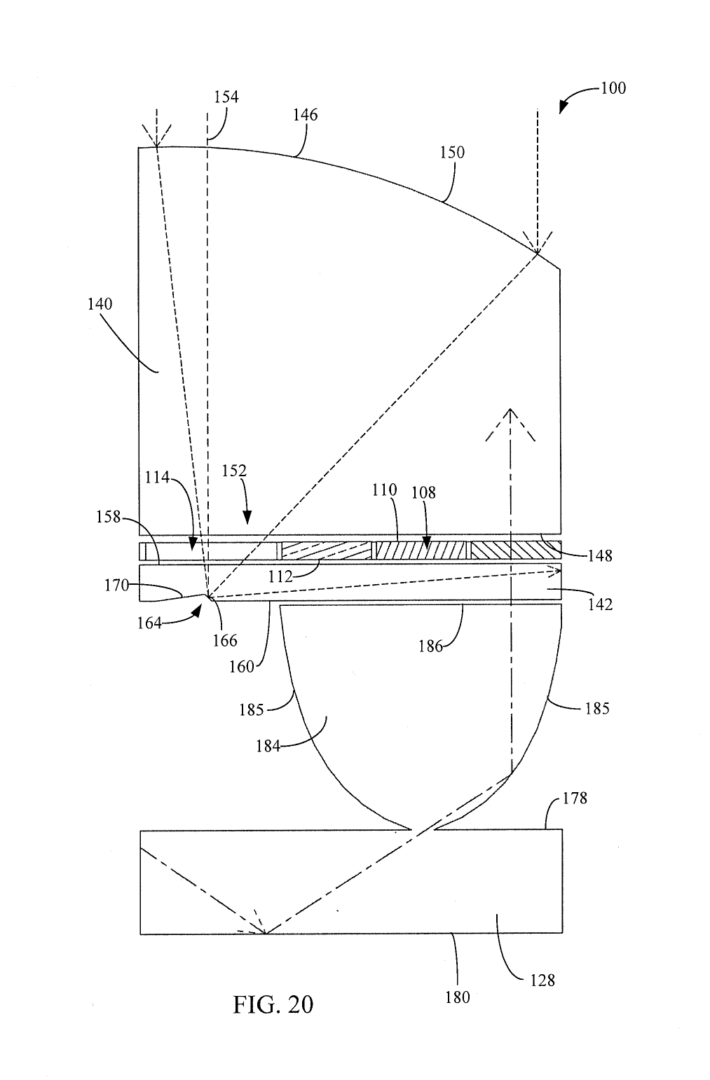

As indicated, the geometry of the light redirecting elements 164 is typically configured to reduce the loss of light through the major surfaces 158, 160 of the concentrator light guide 142. In an example, each light redirecting element 164 includes a tapered surface 170 (e.g., as shown in FIGS. 20-23). The tapered surface 170 is oriented at a shallow angle relative to the major surface 160 such that light propagating in the concentrator light guide 142 toward the output edge 162 and incident on the tapered surface 170 of the light redirecting element 164 continues to propagate in the concentrator light guide 142 toward the output edge 162 by total internal reflection.

Solar Cell

The solar cell 144 (e.g., a photovoltaic cell) is adjacent the output edge 162 of the concentrator light guide 142 and converts the energy of the light output from the output edge 162 of the concentrator light guide 142 and incident on the solar cell 144 into electrical energy. While the area of the solar cell 144 is approximately equal to the area of the output edge 162, the primary concentrator 140 and the concentrator light guide 142 cause the light energy incident on the solar cell 144 to be approximately equal to the energy of the ambient light incident on the area of the display 106 multiplied by a transmission efficiency factor that is less than 100%.

The solar cell 144 is coupled to the rechargeable power source 103. The rechargeable power source 103 includes a battery 172 to supply power to operate the display apparatus 100, and in some embodiments, to operate the other features of the mobile or handheld device. An interface 174 is configured to receive operating power from an external power source to charge the battery 172. The interface 174 is also configured to supply operating power in place of at least some of the power supplied from the battery 172. In some embodiments, the interface 174 steps up the voltage of the electrical power provided by the solar cell 144 in excess of that needed by the battery 172 and supplies the excess electrical power to other electricity-consuming devices or the grid.

In some embodiments, the electrical energy provided by the solar cell 144 provides electrical power used by the rechargeable power source 103 to recharge the battery 172 and/or supplement the supply of power to the display 106, controller 109, and other components of the device, thereby prolonging the battery life of the battery 172. In this disclosure, the term “battery life” is the time that a fully-charged battery is capable of supplying power to operate the display apparatus 100 and/or the other features of the mobile or handheld device before requiring recharging.

Backlight Unit

In the example shown in FIGS. 1 and 2, the display apparatus 100 includes a backlight unit to backlight the display apparatus 100. The backlight unit includes a backlight light guide 128 and a light source 176.

Similar to the concentrator light guide 142, the backlight light guide 128 is a solid article having a first major surface 178 and a second major surface 180 opposite the first major surface 178. The length and width dimensions of each of the major surfaces 178, 180 are greater, typically ten or more times greater, than the thickness of the backlight light guide 128. At least one edge surface extends between the major surfaces 178, 180 of the backlight light guide 128 in the thickness direction, the total number and geometry of the edge surfaces depending on the configuration of the backlight light guide 128. The edge surface through which light from the light source 176 is input to the backlight light guide 128 will now be referred to as a light input edge 182. Light input to the backlight light guide 128 through the light input edge 182 propagates along the backlight light guide by total internal reflection at the first major surface 178 and the second major surface 180.

The backlight light guide 128 includes light extracting elements 184 configured to extract light from the backlight light guide 128 and to direct the extracted light preferentially toward the pixel sets 108. The light extracting elements 184 are in, on, or beneath at least one of the major surfaces 178, 180. Light extracting elements 184 that are in, on, or beneath a major surface will be referred to as being “at” the major surface. Each light extracting element 184 functions to disrupt the total internal reflection of the propagating light that is incident on the light extracting element 184. In the example shown in FIG. 2, the light extracting elements 184 are at the second major surface 180 and reflect light toward the first major surface 178 so that the light exits the backlight light guide 128 through the first major surface 178. In another embodiment, the light extracting elements are at the first major surface 178 and transmit light through the light extracting elements and out of the first major surface 178. In another embodiment, both types of light extracting elements are present.

Exemplary light extracting elements 184 include light-scattering elements, which are typically features of indistinct shape or surface texture, such as printed features, ink jet printed features, selectively-deposited features, chemically etched features, laser etched features, and so forth. Other exemplary light extracting elements include micro-optical elements. Exemplary micro-optical elements are described in U.S. Pat. No. 6,752,505 and, for the sake of brevity, are not described in detail in this disclosure.

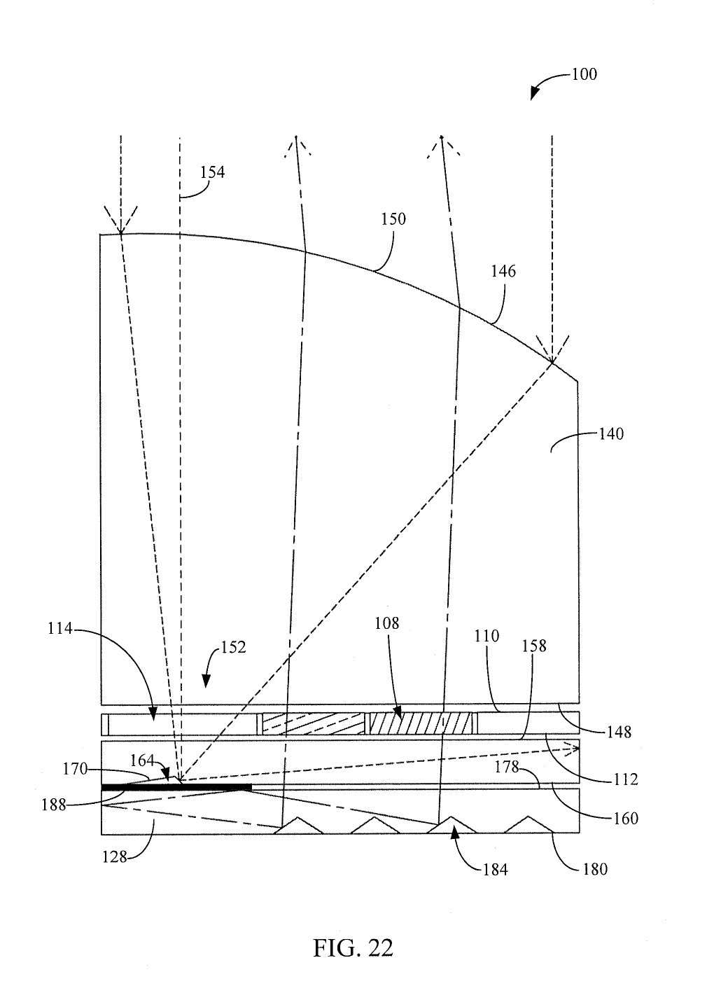

The light extracting elements 184 are arranged to preferentially direct the light extracted from the backlight light guide 128 toward the pixel sets 108, but not toward the transmissive regions 114. Extracted light that passes through the transmissive region 114 results in small areas of unmodulated light that degrade the contrast ratio of images displayed by the display apparatus 100. Light blocking elements that mitigate this effect are described below with reference to FIG. 22.

FIG. 20 shows an example of a backlight light guide 128 having a light extracting element 184 arranged at the first major surface 178 thereof. The light extracting element 184 is one of a two-dimensional array of light extracting elements on major surface 178. The remaining light extracting elements have been omitted to simplify the drawing. Each light extracting element 184 includes a light output surface 186 aligned with a respective pixel set 108 but not with the transmissive region 114. Light propagating in the backlight light guide 128 in alignment with light extracting element 184 enters the light extracting element 184 and is output from the light extracting element directly or after one or more reflections at the side surface 185 of the light extracting element 184. The light exits the light extracting element 184 through the light output surface 186 and is incident on the pixel set 108.

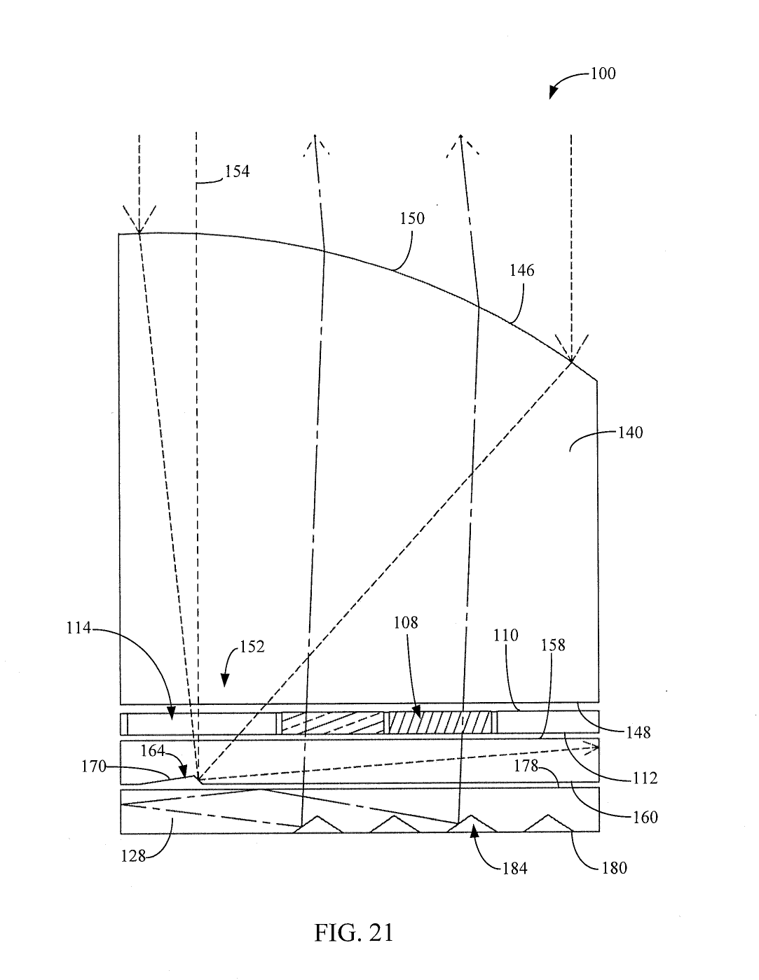

FIG. 21 shows another example of backlight light guide 128 having light extracting elements 184 arranged at the second major surface 180 of the backlight light guide 128. The light extracting elements 184 are located and configured to extract light from the backlight light guide 128 preferably only at locations aligned with the pixel sets 108 of the display 106 and not at locations aligned with the transmissive regions 114 of the display 106. Light propagating in the backlight light guide 128 and incident on the light extracting elements 184 is reflected toward the first major surface 178 of the backlight light guide 128. The light passes through the first major surface 178 and is incident on the pixel set 108.

In some embodiments, a reflective or light absorbing material 188 is disposed between the concentrator light guide 142 and the backlight light guide 128 at one or more locations to prevent light extracted from the light guide from passing through the transmissive region 114. Light extracted from the backlight light guide 128 through the first major surface 178 and incident on the reflective or light absorbing material 188 is reflected back into the backlight light guide or absorbed by the material. For example,

FIG. 22 shows an embodiment similar to that of FIG. 21, but additionally including the reflective or light absorbing material 188 disposed between the concentrator light guide 142 and the backlight light guide 128. Layer 188 can be a reflective layer deposited in selected regions of the concentrator light guide 142 in alignment with transmissive regions 114.

With continued reference to FIG. 2, the light source 176 is adjacent the light input edge 182 to edge light the backlight light guide 128 such that light from the light source 176 propagates in the backlight light guide 128 by total internal reflection at the opposed major surfaces. The light source 176 includes one or more solid-state light emitters 177. Exemplary solid-state light emitters include such devices as LEDs, laser diodes, and organic LEDs (OLEDs). In an embodiment where the solid-state light emitters are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color.

Although not specifically illustrated in detail, the light source 176 also includes structural components (e.g., printed circuit board (PCB), mounting bracket, etc.) to retain the light source 176. The light source 176 may additionally include circuitry and/or electronics for controlling and driving the light source, and any other appropriate components. Typically, the light source 176 is controlled by the controller 109 and is powered by the rechargeable power source 103.

Integrated Light Guide Embodiments

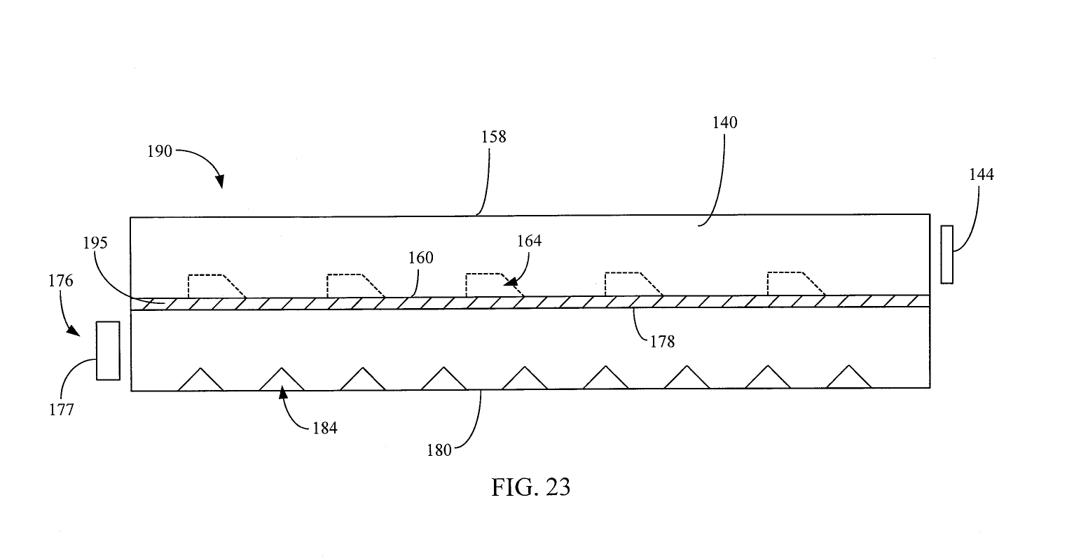

FIGS. 1 and 2 show the backlight light guide 128 and the concentrator light guide 142 as separate components of the display apparatus 100. Light extracted from the backlight light guide 128 passes through the concentrator light guide 142 to back light the display 106. In other embodiments, the backlight light guide 128 and the concentrator light guide 142 are combined into an integrated light guide 190 (FIGS. 23-25) that provides illumination for the display 106 and redirects the focused ambient light incident thereon toward the solar cell 144.

FIG. 23 shows an exemplary embodiment in which the integrated light guide 190 is a multi-layer structure formed by the backlight light guide 128 and the concentrator light guide 142 with a low-index layer 195 therebetween. In one embodiment, the low-index layer 195 is a layer of material having an index of refraction lower than the respective indices of refraction of the concentrator light guide 142 and the backlight light guide 128. In another embodiment, the low-index layer 195 is a layer of air or another gas. The low-index layer 195 acts as a cladding material for both the concentrator light guide 128 and the backlight light guide 142, and prevents low-angle light from crossing from one light guide to another.

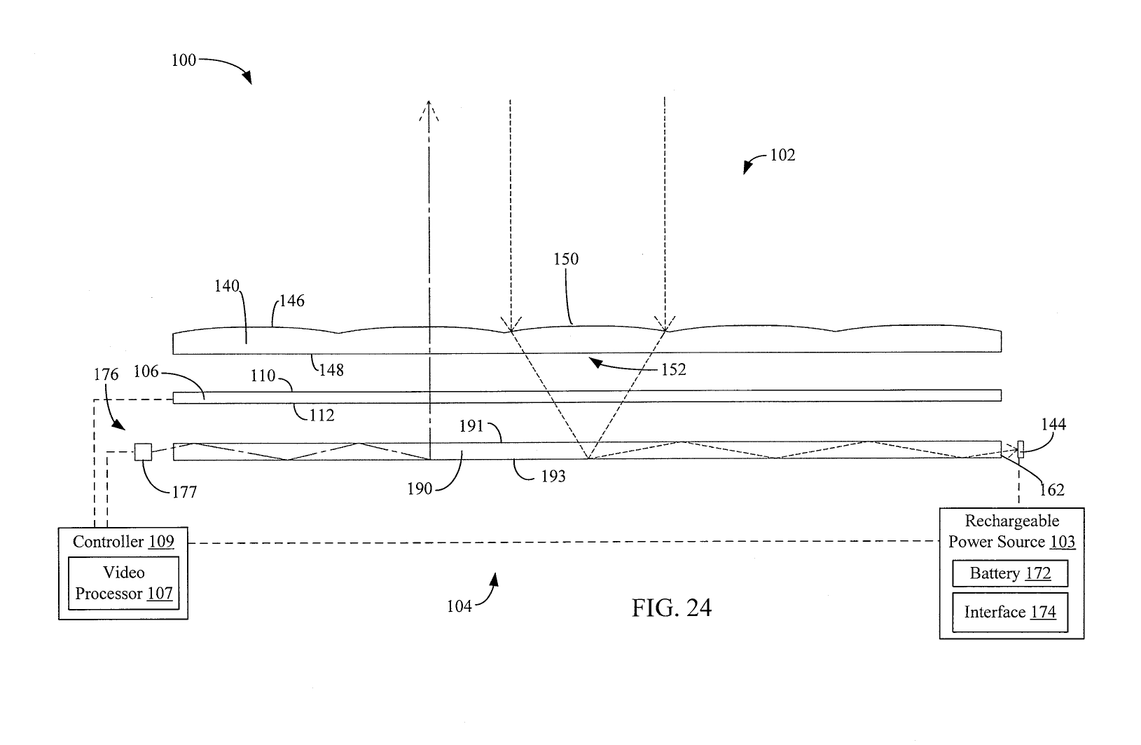

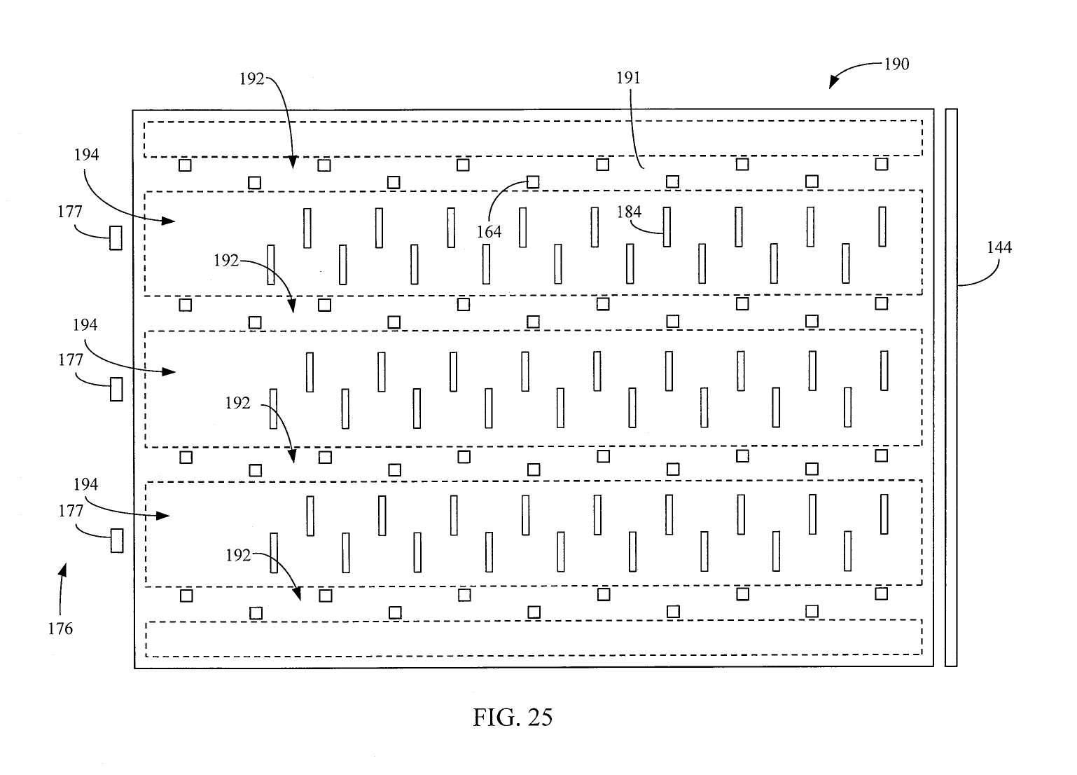

FIGS. 24 and 25 show another exemplary embodiment in which the integrated light guide 190 is a single layer. The integrated light guide 190 includes both light redirecting elements 164 and light extracting elements 184. The light redirecting elements 164 and the light extracting elements 184 are arranged within spatially-separated regions 192, 194 at the major surface 191, 193 of the integrated light guide 190. The light extracting elements 184 extract light input to the integrated light guide 190 from the light source 176. The light redirecting elements 164 redirect ambient light received from the primary concentrator 140 toward the solar cell 144 by total internal reflection through the region 192 populated with light redirecting elements 164. The light redirecting elements 164 are arranged in a staggered pattern to minimize extraction of the concentrated light by downstream light redirecting elements 164. In some embodiments, the light redirecting elements 164 are additionally configured to extract light input to the integrated light guide 190 from the light source 176 (e.g., via configuration of the tapered portion 170 of the light redirecting element 164 (FIG. 20)) in addition to light extracting elements 184.

### Alternative Embodiment

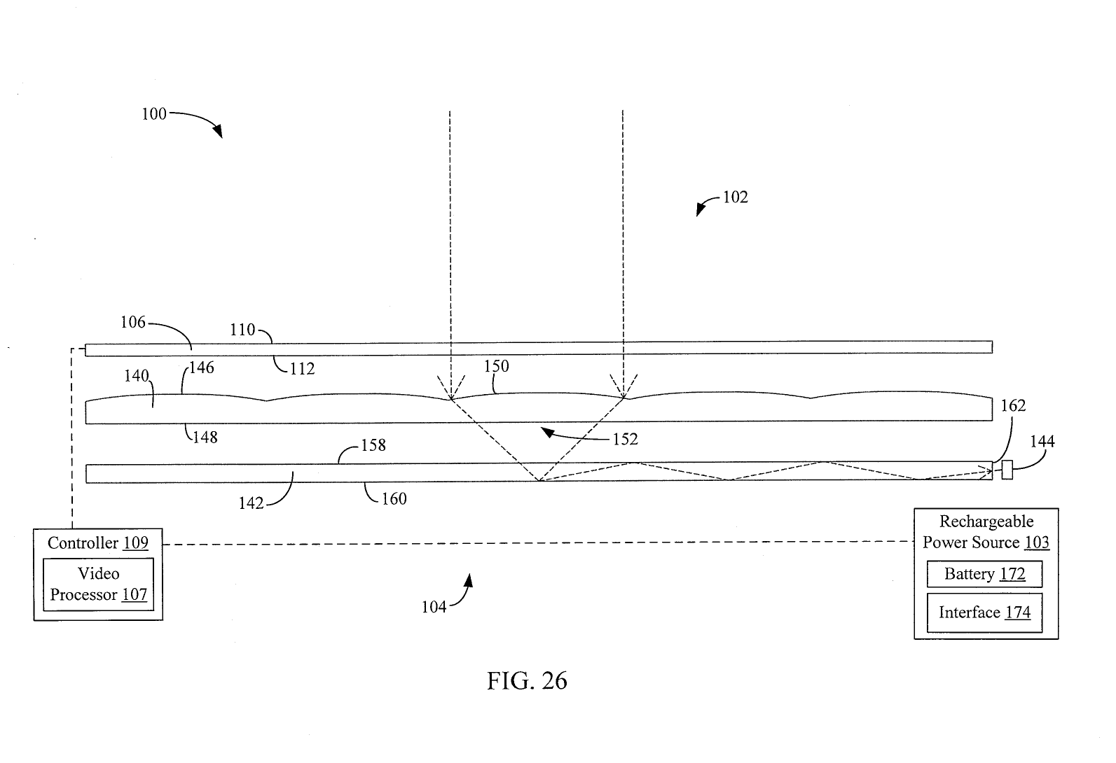

In the embodiments described above, the primary light concentrator 140 and the concentrator light guide 142 are arranged in tandem with the display 106 such that the display 106 is located between the primary light concentrator 140 and the concentrator light guide 142. FIG. 26 shows an exemplary embodiment of the display apparatus in which both the primary light concentrator 140 and the concentrator light guide 142 are proximate the second major surface 112 of the display 106 such that the primary light concentrator 140 is located between the display 106 and the concentrator light guide 142. This arrangement is suitable for use in connection with an optically-transmissive reflective or emissive display, such as a cholesteric LCD. Light incident on the first major surface 110 of the display 106 passes through the display 106 due to the optical transmissivity of the display 106. The light passed through the display is incident on the first major surface 146 of the primary light concentrator 140, which focuses the light onto the light redirecting elements 164 at the major surface 158, 160 of the concentrator light guide 142. The light redirecting elements 164 redirect the light to propagate in the concentrator light guide 142 via total internal reflection toward the solar cell 144.

In this disclosure, the phrase “one of” followed by a list is intended to mean the elements of the list in the alternative. For example, “one of A, B and C” means A or B or C. The phrase “at least one of” followed by a list is intended to mean one or more of the elements of the list in the alternative. For example, “at least one of A, B and C” means A or B or C or (A and B) or (A and C) or (B and C) or (A and B and C).

What is claimed is:

1. A display apparatus, comprising:
a display;
a primary light concentrator arranged in tandem with the display, the primary light concentrator to concentrate incident light into an array of output regions;
a concentrator light guide to receive light from the primary light concentrator, the concentrator light guide comprising light redirecting elements aligned with the output regions of the primary light concentrator to redirect light from the primary light concentrator along the concentrator light guide toward an edge thereof; and
a solar cell adjacent the edge of the concentrator light guide.

2. The display apparatus of claim 1, in which the display is located between the primary light concentrator and the concentrator light guide, and comprises transmissive regions aligned with the output regions of the concentrator.

3. The display apparatus of claim 2, in which:
the display comprises pixel sets; and
the pixels of each of the pixel sets and a respective transmissive region are arranged in a one-dimensional array.

4. The display apparatus of claim 2, in which:
the display comprises pixel sets; and
the pixels of each of the pixel sets and a respective transmissive region are arranged in a two-dimensional array.

5. The display apparatus of claim 2, in which:
the display comprises pixel sets; and
the pixels of each of the pixel sets and a respective transmissive region are arranged concentrically.

6. The display apparatus of claim 2, in which:
the display comprises pixel sets; and
the pixels of a pair of the pixel sets and a respective transmissive region are arranged in a 3×3 array.

7. The display apparatus of claim 2, in which the primary light concentrator comprises an array of light concentrator elements that define the output regions, the light concentrator elements aligned with the transmissive regions of the display.

8. The display apparatus of claim 2, in which the light concentrator elements and the transmissive regions are aligned to reduce an angle through which the light concentrator elements refract the light to pass through the transmissive regions.

9. The display apparatus of claim 2, in which each of the transmissive regions comprises a region of varying refractive index.

10. The display apparatus of claim 2, in which:
the display comprises an organic light-emitting diode display panel; and
the organic light-emitting diode display panel comprises windows devoid of light-generating structure, the windows providing the transmissive regions of the display.

11. The display apparatus of claim 2, in which:
the display comprises a liquid crystal display panel; and
the liquid crystal display panel comprises a polarizer film having windows defined therein, the windows constituting parts of the transmissive regions of the display.

12. The display apparatus of claim 1, in which the primary light concentrator is located between the display and the concentrator light guide.

13. The display apparatus of claim 12, in which the display comprises a reflective liquid crystal display panel.

14. The display apparatus of claim 1, in which the primary light concentrator comprises an array of light concentrator elements that define the output regions.

15. The display apparatus of claim 14, in which:
the display comprises pixel sets;
each of the light concentrator elements is associated with no more than three of the pixel sets.

16. The display apparatus of claim 14, in which each of the light concentrator elements comprises a respective lenslet.

17. The display apparatus of claim 14, in which each of the light concentrator elements comprises a respective diffractive optical element.

18. The display apparatus of claim 14, in which each of the light concentrator elements comprises a respective holographic element.

19. The display apparatus of claim 14, in which each of the light concentrator elements comprises a region of varying refractive index.

20. The display apparatus of claim 1, in which the display comprises an organic light-emitting diode display.

21. The display apparatus of claim 1, in which the display comprises a liquid crystal display panel and a backlight unit to back light the liquid crystal display panel.

22. The display apparatus of claim 21, in which the liquid crystal display panel comprises a polarizer film having defined therein windows aligned with the output regions of the primary light concentrator.

23. The display apparatus of claim 21, in which the backlight unit comprises a backlight light guide.

24. The display apparatus of claim 23, in which:
the display comprises pixel sets; and
the backlight light guide comprises light extracting elements configured to extract light from the backlight light guide and to direct the extracted light preferentially toward the pixel sets.

25. The display apparatus of claim 23, in which the concentrator light guide is located between the display and the backlight light guide.

26. The display apparatus of claim 25, further comprising a reflective or light absorbing material disposed between the concentrator light guide and the backlight light guide.

27. The display apparatus of claim 23, in which the backlight light guide and the concentrator light guide are parts of an integrated light guide.

28. The display apparatus of claim 27, in which:
the backlight light guide comprises light extracting elements configured to extract light from the backlight light guide; and
the light extracting elements are spatially separated from the light redirecting elements.

29. The display apparatus of claim 28, in which the light redirecting elements are configured additionally to extract light from the backlight light guide.

30. The display apparatus of claim 23, additionally comprising a low-index layer between the backlight light guide and the concentrator light guide.

31. The display apparatus of claim 1, in which the display comprises a liquid crystal display panel.

32. The display apparatus of claim 1, in which the display comprises a micro electro-mechanical system (MEMS) display panel.

33. The display apparatus of claim 1, in which:
the display comprises pixel sets;
the primary light concentrator comprises an array of light concentrator elements that define the output regions, each of the light concentrator elements associated with more than two of the pixel sets; and
the display apparatus comprises means for reducing image distortion by the light concentrator elements.

34. The display apparatus of claim 33, in which the means for reducing comprises the pixel sets arranged in a non-rectangular array.

35. The display apparatus of claim 33, in which the means for reducing comprises a processor to subject a video signal input to the display to a pre-distortion that cancels the image distortion caused by the light concentrator elements.
